(19) United States
(12) Patent Application Publication
(10) Pub. No.: US 2008/0137540 A1
(43) Pub. Date: Jun. 12, 2008

(54) Method And Apparatus For Analysing Traffic In A Network

(75) Inventor: Dmitri Botvich, Dublin (IE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: CORVIL LIMITED, Dublin (IE)

(21) Appl. No.: 11/722,695

(22) PCT Filed: Dec. 23, 2004
(86) PCT No.: PCT/IE2004/000178

§ 371 Date: Aug. 1, 2007

(30) Foreign Application Priority Data
Dec. 23, 2004 (WO) PCTIE2004000178

(51) Int. Cl. H04L 12/26

(52) U.S. Cl. 370/241

(57) ABSTRACT

Embodiment of the present invention relate to methods of traffic measurement on a network. In some embodiments, the methods include obtaining a measure of shaped traffic before shaping using reference packets injected onto the network at a first location (prior to shaping). The methods may further include measuring the traffic on the network at a second location (after shaping) and using the reference packets for timing purposes.

### FIELD OF THE INVENTION

The present invention relates to communication networks and specifically to packet based data communication networks. In particular, the invention relates to a method of analysis of network traffic before shaping where a probe is positioned along the network after where shaping has occurred.

### BACKGROUND

Numerous communication networks are often used for data communications, including IP (internet protocol) networks, ATM networks and other packet switched communications networks. A communication network is a collection of network elements interconnected so as to support the transfer of information from a user at one network node to a user at another. The principal network elements are links and switches. A link transfers a stream of bits from one end to another at a specified rate with a given bit error rate and a fixed propagation time. The rate at which a buffer is served is the service capacity, which is often measured in bits per second. Other common terms for service capacity are link-rate and bandwidth. Links are unidirectional. Important links are:

optical fibre;

copper coaxial cable;

microwave wireless.

Several incoming and outgoing links meet at a switch, a device that transfers bits from its incoming links to its outgoing links. The name “switch” is used in telephony, while in computer communications, the device that performs routing is called a router; the terms are used interchangeably in this specification. When the rate of incoming bits exceeds that of outgoing bits, the excess bits are queued in a buffer at the switch. The receiver of each incoming link writes a packet of bits into its input buffer; the transmitter of each outgoing link reads from its output buffer. The switch transports packets from an input buffer to the appropriate output buffer. An schematic example of such a network arrangement is shown in FIG. 1 where a router 100 including an input buffer 110 and an output buffer 120 is used to couple one or more incoming links 130 with one or more outgoing links 140.

The quality of a communications network service, as perceived by a user, varies greatly with the state of the network. To make packet-switched networks economically viable, it is necessary to be able to guarantee quality while reducing capital investment and operating expenses.

Degradation in the perceived quality of a service can often be traced back to loss or delay of data packets at a node or switch in the network. User satisfaction can be guaranteed by managing loss and delay of packets at those nodes where congestion can occur.

Typically, users transmit bits in bursts: active periods are interspersed with periods of inactivity. The peak rate of transmission cannot exceed the link rate. The mean rate of transmission, by definition, cannot exceed the peak rate Loss and delay of data packets at a node in the network arise from the queuing of packets in the buffers of switches or routers. Buffers are required to cope with fluctuations in the bit-rate on incoming links. However, if the buffers are too small, packets will be lost as a result of buffer overflow; if the buffers are too large, some packets will experience unacceptable delays. For a given buffer-size, loss and delay can be reduced by increasing the capacity of the outgoing link.

To eliminate packet loss entirely, it would be necessary to increase the capacity of the outgoing link to equal the sum of the capacities of the incoming links. This is prohibitively expensive. Nevertheless, it is a strategy employed sometimes by network operators who take a conservative view on assuring network quality of service.

Another known technique is based on an understanding that it is unnecessary to eliminate packet loss and unacceptable packet delay in order to give satisfactory perceived quality. It is enough to keep their frequency within predetermined bounds. These bounds are referred to as Quality of Service (QoS) targets.

The optimal way to ensure satisfactory perceived quality is to provide the minimum capacity that will guarantee the QoS targets. This minimum capacity is referred to as the Bandwidth Requirement (BWR) of the bit-stream. It lies somewhere between the mean rate and the peak-rate requirement.

Various techniques are known for the measurement and estimation of BWR that will guarantee QoS targets. However, a problem that arises in these measurements is that the traffic in all likelihood has been shaped before arriving at the point of measurement. In networks, traffic aggregates experience so-called “shaping effects” whilst traversing through networks.

A traffic aggregate is any grouping of network traffic. An aggregate is usually defined using a packet filter. A traffic aggregate may be defined by a variety of different parameters including the source, destination and type of traffic. The traffic aggregate may be real in the sense that it could define all traffic arriving through a particular router. Alternatively, a traffic aggregate could be artificial in the sense, for example, that it could comprise traffic being analysed for a possible reconfiguration on the network rather than a current implementation. Thus, for example, a traffic aggregate may be defined to investigate the possibility of changing router configuration or to investigate the possibility of installing a new router to handle some traffic from one or more existing routers.

The shaping of the aggregates is caused by, inter-alia, queuing, packet delay and jitter at routers, arising from a number of different reasons. One reason in particular is the use of packet buffering and the different time required by a router to process different packets. Additionally router/switch internal procedures influence delays and jitter also. It is important to emphasize that by shaping, is meant practically everything that influences packet jitter and packet losses.

Traffic measurement typically involves using counters to record values such as, for example, the number of data packets and the volume of data moving along a link. These counters are periodically inspected, for example every 5 mSec, and the values used in the measurement of statistical characteristics regarding the performance of the network. It will be appreciated that a variety of different statistical measurement techniques are available. These statistical characteristics include the statistical Quality of Service (QoS) parameters such as the Essential Bandwidth with loss and/or delay targets. Specific statistical descriptors for the assignee/applicant of the present invention include CORVIL™ traffic descriptors (CTD's) and CORVIL™ essential bandwidth. A description of the concept of essential bandwidth is contained in F. P. Kelly, S. Zachary and I. Zeidens, editors, Stochastic Networks: Theory and Applications, Royal Statistical Society Lecture Notes Series, Chapter 8, pp. 141-168, Oxford University Press, 1996, the entire contents of which are hereby incorporated by reference. It will be appreciated that a variety of different traffic descriptors and bandwidth measurement tools are employed by different suppliers and the present invention should not be construed as being limited to any particular method of calculation or implementation.

As explained above, traffic descriptors and bandwidth measurement tools are sensitive to shaping. In fact, essential bandwidth is particularly sensitive to shaping as it uses a peak rate in its calculation. As result of shaping the QoS related statistical characteristics of the same traffic aggregate are different before and after shaping, or more generally at different measurement points (i.e. the location of probes at different routers/switches).

Some examples of when it is desirable to get such measurements are set out below. These examples are not exhaustive, but merely exemplary. In the first example, hereinafter referred to a 1-layer probe where we are interested in reliable measurements of traffic before it is shaped by the router attached to the probe as illustrated in FIG. 2. In the second example, hereinafter referred to as a 2-layer probe scenario, we are interested in reliable measurements of traffic not only before it is shaped by the router attached to the probe but also before it is shaped routers of previous layer as illustrated in FIG. 3.

In FIG. 2, the probe is located after router R1. We are interested in the essential bandwidth measurements before router R1, i.e. on links (R2, R1), (R3, R1), (R4, R1). This is 1-layer scenario: we are interested in measurements just before the router attached to the probe.

As described above, a major challenge with measurements of traffic or bandwidth requirements\usage in the mentioned scenario is that when a traffic aggregate goes through a router it is shaped, and, as consequence of this, its statistical properties are changed. So that the above described use of counters is unsuitable to provide a statistical measure of the traffic before shaping. As result of this the traffic descriptors (e.g. CTDs) and/or bandwidth estimates (e.g. CORVIL™ essential bandwidth) measured “before router” are different from measurements made “after router”. The difference is typically larger for higher loads.

The consequences of this will now be explained, with reference to FIG. 3, in which the probe is located after a router R1. We are interested in traffic measurements before router R1, in particular, on links (R2, R1), (R3, R1), (R4, R1), but also before routers R2, R3, R4. This is a 2-layer scenario: we are interested in measurements not only before router attached to the probe, but also before the next layer routers. However, the traffic aggregate is shaped at each layer, leading to significant measurement errors.

Although, the problem could be solved by increasing the number of probe locations, i.e. such that there was a probe at each point of interest, there are both economic and technical reasons why this may not be possible or practical. For example, the cost of deploying probes in order to make QoS measurements may be uneconomic.

### SUMMARY

Embodiments of the present invention may include creating reference packets on a network and using the reference packets when performing network traffic analysis to effectively negate any shaping that has occurred. Accordingly, some embodiments of the invention may provide a method of analysing traffic in a network. The method may comprise creating reference packets on the network at a first location and measuring the traffic on the network at a second location, wherein the reference packets are used for timing purposes in the measurement of the traffic. The reference packets may be injected as additional packets into traffic on the network. Alternatively, the reference packets may be created marking of packets in the traffic. This marking need only be sufficient so as to allow the identification of the marked packets elsewhere as reference packets.

The measurement process may comprise the use of at least one counter. The at least one counter may be for counting the number of data packets and/or for counting the volume of data in data packets. The method may inspecting the at least one counter at intervals defined by the reference packets. Suitably, the inspecting may include saving the counter values. Each of the reference packets of the first series may be identified by an identifier. The method may also comprise comparing the identifier for a received reference packet in the first series with the identifier for the previously received reference packet in the first series to determine whether a reference packet has been lost. The method may further comprise calculating interpolated counter values for a reference packet lost from the first series. The identifiers used within the first series of reference packets may comprise a sequential sequence. Time stamps may be used as identifiers in the first series. The method may additionally comprise injecting a second series of reference packets onto the network at the first location, wherein each of the reference packets in the first series comprise a first category of traffic and each of the reference packets in the second series comprise a second category of traffic.

Various embodiments of the invention may provide a method of analysing traffic in a network comprising a) identifying a reference packet from a first series of reference packets in traffic on the network, and b) performing a measurement of the traffic using the reference packet as a timing indicator in the measurement. The measurement may comprise the inspection of at least one counter. The at least one counter may count the number of data packets in the traffic and/or the volume of data in data packets. The method may also comprise saving the measurement. Each reference packet of the first series may be identified by an identifier. The method may further comprise comparing the identifier for a received reference packet in the first series with the identifier for the previously received reference packet in the first series to determine whether a reference packet has been lost. As a result of such a determination, the method may include calculating an interpolated measurement. The identifiers used for the first series of reference packets may comprise a sequential sequence. The identifiers used for the first series may comprise a time stamp substantially identifying the time a packet was sent. The method may further comprise a) identifying a reference packet from a second series of reference packets in traffic on the network, and b) performing a measurement of the traffic in response to the identification of the reference packet from the second series.

Additional embodiments of the invention may provide a network probe for performing a measurement of network traffic, the probe comprising a first counter for recording the quantity of data in packets of an aggregate passing by the probe and a second counter for recording the number of packets of the aggregate passing by the probe, the probe being adapted to obtain a measure of the counter values in response to identifying a reference packet in a first series of reference packets. The probe may be further adapted to store the obtained measures of the counter values. A probe may be adapted to compare the identifier for a received reference packet in the first series with the identifier for the previously received reference packet in the first series to determine whether a reference packet has been lost. The probe may further adapted to calculate interpolated counter values for a reference packet lost from the first series, where such a determination is made. The first and second counters may record values for traffic of a first class in the aggregate, and the probe may further comprise a third counter for recording the quantity of data in packets of a second class in an aggregate passing by the probe and a fourth counter for recording the number of packets of the second class of the aggregate passing by the probe, the probe being further adapted to obtain a measure of the third and fourth counter values in response to identifying a reference packet in the second series of reference packets.

Further embodiments of the invention may provide a reference traffic generator adapted to create a first series of reference packets on a network. The first series of reference packets may suitably comprise a periodic sequence of packets for subsequent use by a probe on the network as timing markers when performing a statistical measure of traffic between the timing markers on the network. The first series of reference packets may be created by injecting them onto the network and/or by marking existing packets on the network.

The reference traffic generator may be further adapted to sequentially identify each reference packet in the first series with an identifier, e.g. a time stamp.

The reference traffic generator may be further adapted to place a second series of reference packets onto the network, where each of the reference packets in the first series comprises a first category of traffic and each of the reference packets in the second series comprises a second category of traffic.

Embodiments of the invention may also provide for a system comprising:
a) a network for the transmission of packets,
b) a reference traffic generator for placing reference packets onto the network,
c) a probe for performing measurements of traffic on the network using the reference packets, and d) at least one router positioned between the reference traffic generator and the probe on the network. The at least one router may comprise one or more of the following: a WFQ scheduler, a LLQ scheduler and a priority scheduler.

### BRIEF DESCRIPTION OF THE DRAWINGS

Exemplary embodiments of the present invention will now be described with reference to the accompanying drawings in which:

FIG. 1 is an example of a router in a packet based network,

FIG. 2 is an exemplary first scenario where embodiments of the present invention may be employed,

FIG. 3 is an exemplary second scenario where embodiments of the present invention may be employed,

FIG. 4 is a exemplary implementation of the present invention, in accordance with various embodiments,

FIG. 5 is an illustration of a mode of operation of the invention, in accordance with various embodiments,

FIG. 6 is an exemplary probe according to the invention, in accordance with various embodiments,

FIG. 7 is an exemplary method according to embodiments of the invention, and

FIG. 8 is a further exemplary method according to embodiments of the invention.

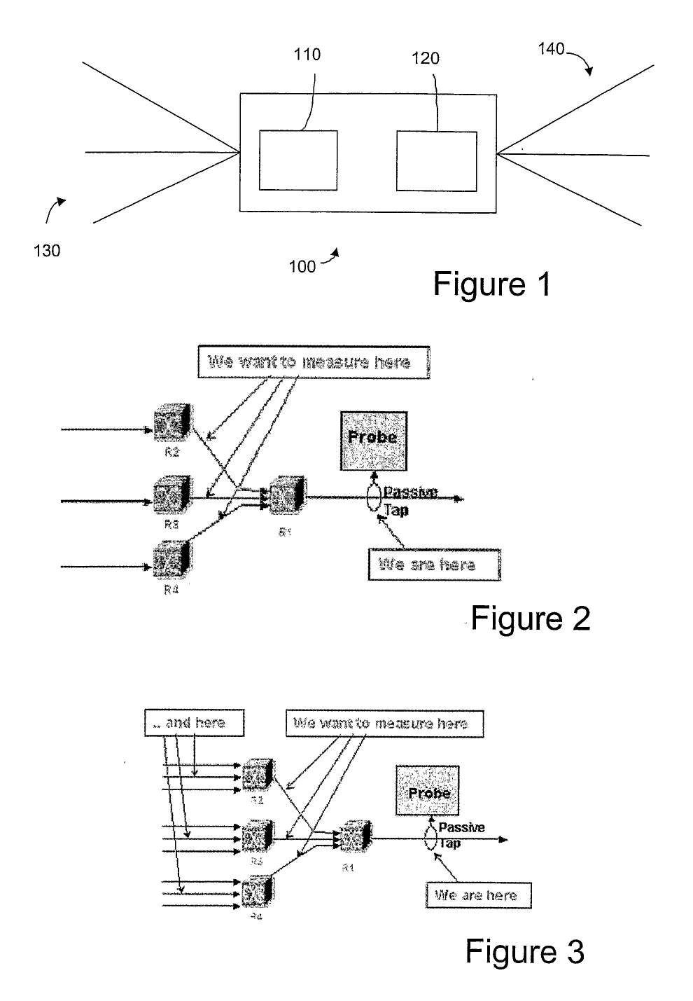

### DETAILED DESCRIPTION OF THE DRAWINGS

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context 5 dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

As explained above in relation to the prior art, traffic measurement techniques in a network typically employ counters to record values including, for example, the number of data packets and the volume of data in packets moving along a link. These counters may periodically be inspected, for example every 5 ms, and the inspected counter values used in the measurement of statistical characteristics regarding the performance of the network. As explained above, shaping may alter the characteristics of the traffic. Thus, for example, traffic which is initially contained in a 5 ms interval prior to shaping may be expanded to be contained within a 20 ms interval after shaping. Accordingly, if the statistical calculations are based on measurements performed on the shaped traffic every 5 ms, the calculated figures will at best be inaccurate for traffic prior to shaping.

Embodiments of the present invention solve the problems of the prior arts using reference (timing) packets. These timing packets may be mixed into the normal traffic on the network at a location of interest prior to where shaping occurs. Subsequently, these reference packets may be used as timing indicators when performing network traffic analysis at a point of measurement in the network positioned after the shaping. The term “normal traffic” is meant to signify any traffic of interest (e.g. a traffic aggregate of interest) on the network other than the reference packet traffic.

Various embodiments may comprise two main elements. The first element may be responsible for creating at least one series of reference packets on the network and the second may be responsible for monitoring the traffic on the network. The series of reference packets may be injected as separate packets onto the network. The series of reference packets may also be created by marking packets in the existing traffic as reference packets. This marking of packets may be achieved by including a time stamp within the packet. These time stamps may then be used subsequently in the traffic analysis. The method may in fact adopt the technique of marking all or substantially all packets, e.g. by means of a time stamp. In this scenario, the traffic might be analysed using the markings as references to reconstruct the original timings, i.e. to group packets within 5 mSec groupings. A combination of the two techniques of marking and injecting may also be employed, i.e. where traffic conditions permit the second method of marking existing packets to be used and when they don't the first method is used. For the purposes of simplicity, the application will now be described in greater detail with reference to the method of injecting packets onto the network, although it will be appreciated that the methods and systems described may be readily modified to adopt the method of marking existing packets as reference packets.

More than one series of reference packets may be injected onto the network where it is desired to analyse different traffic classes within the normal traffic (explained in greater detail below). The individual elements of the system may be implemented in a number of different devices including as part of a router\switch. For simplicity, however, embodiments of the present invention will be described with reference to implementation of the measurement element as a passive probe tapped to a link of interest in a communications network. Some exemplary configurations for the first element responsible for injecting the reference packets on the network are also set out in detail below.

The probe itself may be of any conventional design, since the embodiments lie primarily in the method of analysis and not the method of inspection of the packets. For example, in one arrangement the probe may be used to extract information from packets passing over the link, with the identification of the traffic aggregate and subsequent operations of the method being performed elsewhere on the basis of the information extracted by the probe.

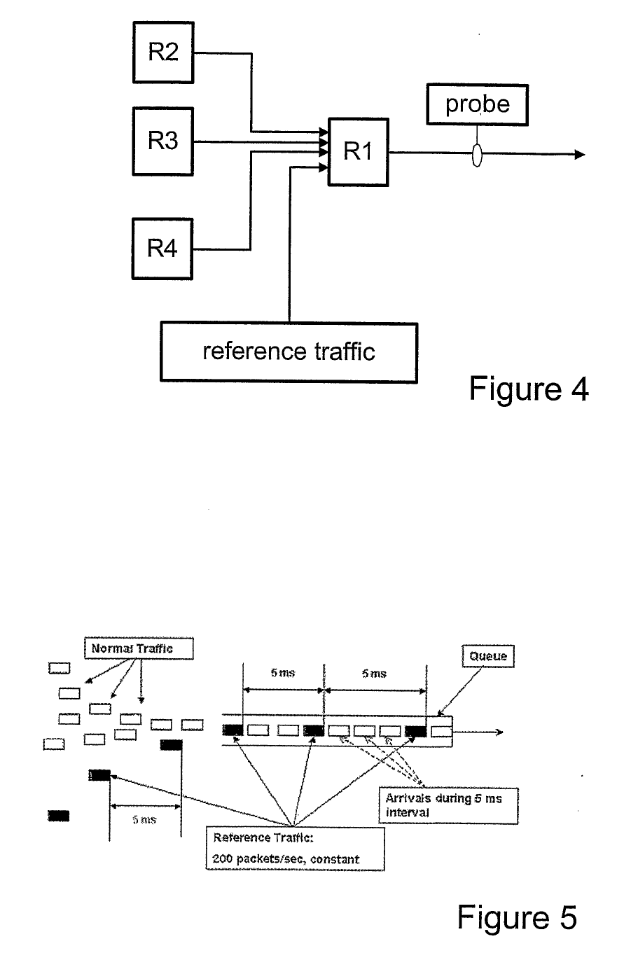

The idea of the proposed method may be described, in simple exemplary terms, with reference to the 1-layer scenario in which the router preceding the probe has a first in first out (FIFO) scheduler. Consider the case, as shown in FIG. 4, where in addition to traffic from routers R2, R3 and R4, an additional traffic stream is provided comprising a series of reference packets entering onto the network at a first location, i.e. into the router R1 (we will refer to this traffic as “reference traffic”).

For the sake of illustration, we will assume that reference traffic is a User Datagram Protocol (UDP) connection with a constant packet rate, for example of 200 packets/sec. It will be appreciated that for this exemplary rate, the time difference between successive packets is 5 ms. It will be appreciated that time difference between arriving packets at entry to the queue of the router is also 5 ms (or very close to 5 ms) (see FIG. 5). In the interval between two successive reference packets, e.g. I^{th} and (I+1)^{th}, other packets may have joined the queue from other traffic sources (R2,R3,R4).

In a FIFO queue, packets that arrived during the 5 ms interval between I^{th} and (I+1)^{th} reference packets, may similarly leave the queue of the router between the reference packets.

Accordingly, packets arriving at the probe between these I^{th} and (I+1)^{th} reference packets may correspond to the packets which arrived at the router R1 in the time window 5 ms between the I^{th} and (I+1)^{th} packets. Accordingly, an accurate traffic measurement of the pre-shaped traffic may be made using the reference packets as timing markers instead of a conventional timer. Replacement of a conventional timer with timing markers may be readily implemented by those skilled in the art. The method may be applied to any aggregate of interest identified by probe, for example through appropriate filtering.

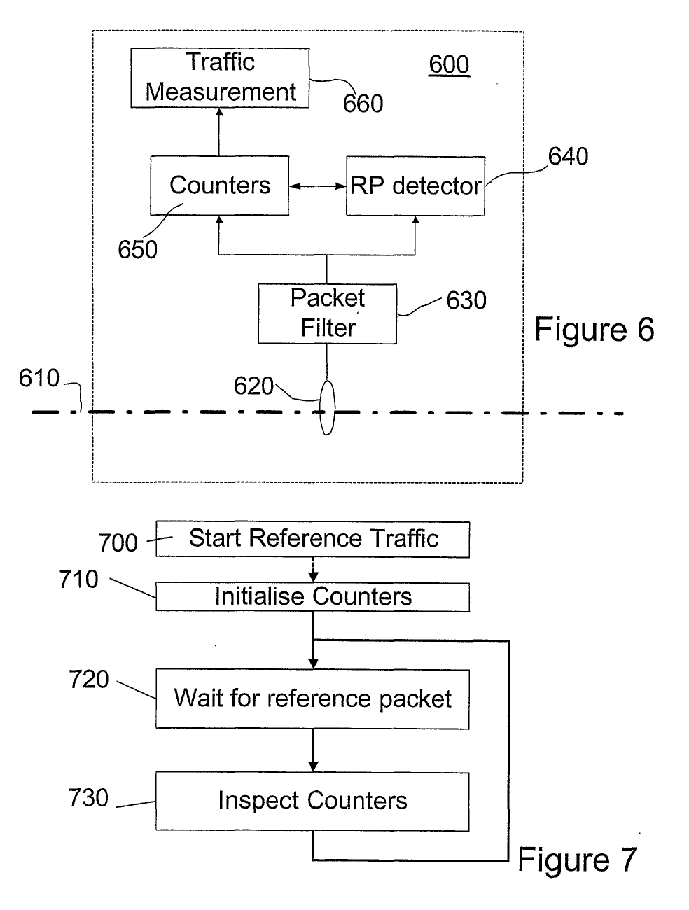

An exemplary probe 600 for implementing the invention will now be described with reference to FIG. 6. The probe 600 may comprise a passive tap 620 for connecting to a link of interest 610 in a network. A traffic aggregator may be used to identify a traffic aggregate of interest. An exemplary traffic aggregator might be a packet filter 630. As new packets arrive at the probe 600 and are identified as being from an aggregate of interest, counters 650 may be used to record packet statistics, e.g. the number of packets that have arrived in an aggregate of interest and the volume of data in these packets. The counters may be as previously implemented in the prior art. In the prior art, these counters would have been periodically inspected and their values recorded (e.g. every 5 ms). In the exemplary arrangement shown, a reference packet detection module 640 may detect the arrival of reference packets. The detection of the arrival of a reference packet may be used in the probe to trigger the inspection of the counters. Thus the conventional use of timers has been replaced by the use of reference packets, which may act as timing interval markers. The counter values may be transmitted elsewhere for subsequent analysis or stored internally within the probe for subsequent transmission or analysis by a traffic measurement module 660.

A method of operation, in accordance with various embodiments, will now be explained, with reference to the method of FIG. 7, which may commence with generated reference traffic, comprising a first series of reference packets, being placed (block 700) onto the network at a place of interest from which a measurement is required. This traffic may be placed on the network by any of the methods described below. The module responsible for generating the reference traffic may be separate from the probe, as the two may be physically located at different points in the network. Suitably, the counters within the probe may be initialised (block 710). As packets arrive the individual counters may be updated (as described above). As each reference packet is detected (block 720), the counter values may be inspected (block 730) and either stored\transmitted for subsequent analysis.

It will be appreciated that as the reference packets themselves function as timing markers there may be no need for any clock synchronization between the reference stream generator, the router and/or the probe.

The use of reference packets may provide for accurate timed (e.g. 5 ms) measurements “before router”, which can be readily calculate “before router” traffic statistics, including, but not limited to the proprietary CTDs and/or Essential Bandwidth (mentioned above).

The use of reference packets may introduce an overhead in terms of the additional network traffic caused by the introduction of the reference packets. However, a reference packet size of approximately 40 bytes, which has been calculated as sufficient to include a packet header, packet number and time stamp (discussed below), sent every 5 ms may result in an effective bit rate of (200×40×8) 64 kbt/s. This rate may be reduced significantly by altering the timing between reference packets, e.g. if we were interested in analysing the traffic using 50 ms rather than 5 ms measurements then the reference stream rate is approximately 6.5 kbit/s. Moreover, a variable rate may be used for the reference traffic, i.e. variable inter-packet sending time. For example, if timing intervals are 20 ms and 80 ms, then the reference stream rate may also be 6.5 kbt/s=20×40×8. It will be appreciated that where a variable rate is used, appropriate changes might have to be made on the measurement side.

The above described method may provide significantly improved results. However, a number of additional features may be used to still further improve the results and/or to broaden the applicability of the system and method. These additional features will now be described.

It will be appreciated that one technique used by routers when loads become excessive is to drop packets. Accordingly, there may be the possibility that some reference packets may be lost. If this happens, it may be appreciated that the measurements may no longer be accurate for the time intervals involved with lost reference packets. One solution to this problem may be to uniquely identify individual reference packets in each series. The unique identification may be in the form of packet numbering (where each reference is sequentially numbered) and/or the inclusion of a time stamp in each reference packet. Thus a probe may detect when a packet goes missing. Once detected, a probe may react by, for example, simply interpolating between received packets to estimate the position of the missing reference packet or ignoring the period in question for measurement purposes.

In general, it will be appreciated that if the interval between reference packets is known (e.g. every 5 msec) then simple numbering of reference packets may be sufficient to account for all packets and the accuracy of interval measurement. If the frequency with which reference packets are generated and sent is varying for some reason (as described above), it will be appreciated that time stamping may be required. Using either method of reference packet identification, it is possible to readily address the loss of reference packets and to reconstruct the time interval duration between two successive successful packets.

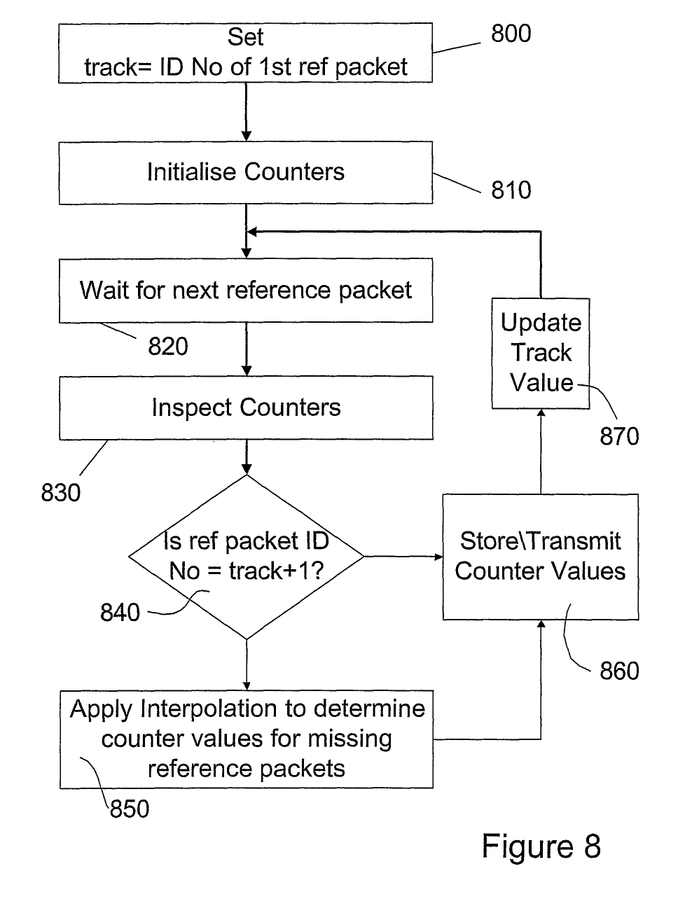

An exemplary method of interpolation is shown in FIG. 8 for a scenario in which the reference packets are sequentially identified. It will be appreciated that a similar method may be applied where time stamp or other markers are used. The method may commence with the identification of the arrival of the first reference packet, at which time a tracking counter may be set (block 800) to the packet ID of the first reference packet. At the same time, the counters 650 may be initialised (block 810). As subsequent reference packets arrive (block 820), the counters may be inspected (block 830) as previously described with reference to FIG. 7. The ID of the arriving reference packet may also be compared (block 840) with an incremented value of the tracking counter (i.e. the ID of the previous reference packet) to ascertain whether an intervening reference packet has gone missing, i.e. if the ID corresponds to a subsequent reference packet in the series. If no reference packet is missing, the counter values may be stored or transmitted (block 860) for subsequent analysis, as described previously, and the track counter may be incremented (block 870) to the next value. On the other hand if a reference packet is found to be missing, then an interpolation process (block 850) may be applied to determine the value of the counters corresponding to the missing reference packet(s). In the case of single missing reference packet, this interpolation (block 850) may comprise simply averaging the current counter values and the previous counter values to derive the interpolated figures. The interpolated and the current counter values may then be stored/transmitted (block 860) and the tracking counter updated accordingly (block 870). In the case where more than one reference packet is missing, it will be appreciated that modified interpolation techniques may be applied without undue complexity.

Although, the above method was explained with respect to the simple scenario of a single router having a FIFO queue, the method may readily be extended to more complicated scenarios and schedulers as discussed below.

With more complicated queuing structures, the solution may be to provide more than one reference streams. Preferably one reference stream may be provided per queue. Furthermore, it may be desirable to have one reference stream for each traffic class of interest. The reference packets may be organized in such a way that they may be scheduled and queued in the same way as the packets of the corresponding traffic classes. One exemplary way in which this may be achieved is to use packet marking. By packet marking is meant the marking the packet to be of a particular traffic class, e.g. by altering the type of service (ToS) parameter in the packet header. In general terms, it is not necessary to know what type of scheduling is used within the routers. The only information required may be the knowledge that packet order in the same queues is preserved. It may be appreciated that this may be generally assumed, as it is true for FIFO, priority scheduler, WFQ scheduler and most other combinations of scheduler, for example for CISCOTM LLQ (Low Latency Queueing).

The method may now be described with reference to its application in a multi-layer situation, where there may be an interest in measurement on links directly attached to the router attached to the probe and also on links not directly attached to the router. An example of such situation is depicted at FIG. 3.

For example, in the situation where we are interested in traffic measurements before router R2, then we might introduce reference traffic before the queue in R2 that must pass through routers R2, R1 to arrive at the probe. If the reference traffic has rate of 200 packets/sec, then we may get 5 ms measurements for any aggregate traffic that uses router R2 and passes through router R1 and by the probe. Load conditions at the routers, in contrast to passive estimation methods, may not play any significant role with respect to accuracy of measurement.

Some exemplary methods of implementation may now be described in greater detail. In particular, the reference traffic may be generated in a router, a probe or an external client. Each of these will now be considered in greater detail.

In the case of a router, the router may have the capability of generating reference traffic. Suitably, the router may be configurable to open a UDP connection and generate traffic either all the time without breaks or according some schedule. A preferred traffic rate is about 200 packets per second, which may correspond to 5 ms measurements. As described above, each packet may contain a sequence number and/or time stamp and such functionality is desirable in a router. Not all routers have the functionality to generate reference traffic. For example, most CISCO™ routers have this functionality indirectly available, through the use of CISCO™ service assurance agent (SA agent), which is a mandatory part of the CISCO™ IOS. Any traffic generated by the SA agent may go through queuing as any external traffic.

An advantage of the SA agent is that it is part Cisco IOS. For those not familiar with CISCO systems, the SA agent corresponds to the previous Response Time Reporter (RTR) feature, which is still the name used within the command line interface. The Service Assurance (SA) Agent is an enhancement to the RTR feature that was introduced in Cisco IOS release 11.2. The feature allows monitor network performance by measuring key Service Level Agreement (SLA) metrics such as response time, network resources, availability, jitter, connect time, packet loss and application performance. Recently (IOS 12), SA Agent was re-implemented to reduce memory by a factor of five and more important the time resolution for sending packets is currently 1 millisecond. It will be appreciated however that the functionality of the systems are under constant revision and change with each release. Nonetheless, the specific selection and use of an available feature to implement the timing markers of the present invention is within the scope of the person of ordinary skill in the art.

For the purposes of embodiments of the present invention, the jitter operation (in Cisco terminology) may be most of interest. The jitter operation is relatively recent addition to the SA agent. The jitter operation first appeared in IOS release 12.0(5)T. Nonetheless, this may allow a user to configure a Type of service (ToS) field, which, as explained above, may allow for the creation of reference traffic, comprising multiple series of reference traffic, for more than one queuing structure in a router thus providing the ability to deal with different schedulers e.g. priority, WFQ, etc, i.e. by providing separate series of reference traffic for each type of service along with separate counters etc.

The SA agent may also provide for flexible scheduling options, which may mean, for example, that the operation of the reference traffic may be started and stopped at required times. As explained above, the SA agent may provide for 1 millisecond precision in the timing of the reference packets. An added advantage of the CISCO™ system is that they may be configured using either a command line interface (CLI) or using Simple Network Management Protocols (SNMP) although not all functionality is currently available through SNMP. In addition, the CISCO systems support most physical and logical interfaces.

As an alternative to the use of a router to generate the reference traffic, the traffic may be generated by a probe. In order to generate reference traffic, the probe may have an additional network interface that may connected to a network interface on an attached router. Once connected, the probe may be used to generate constant packet rate traffic (say 200 packets per second). As explained above, each packet may have a sequence number and/or time stamp. It will be appreciated that a separate probe may be used to generate the reference traffic, in this scenario the probe (or other network device) may be placed upstream of the measurement probe at a location from which measurement is required.

As another alternative, to the use of a router or a probe to generate the reference traffic, the traffic may be generated by an external client. In some embodiments, an external client may comprise a software program running on a computer connected to the same network as the probe. To generate reference traffic a client may open a UDP connection and generate traffic trough the network. The order in which traffic goes through the network may be the following: the client, some routers/switches, the attached router and the probe. The reference traffic rate at the point of entry to the network, for consistency may be the same as used in conventional timed scenarios, e.g. around 200 packets per second, which corresponds to 5 milliseconds measurements. Each packet may have an identifier, e.g. a sequence number and/or time stamp.

Although the invention has been described with reference to the analysis of traffic at a simple probe it will be appreciated that this may be exemplary of the application of the techniques of the present invention as it may not be necessary for a simple probe to be present. For example, the methodology of the present invention may be used in a traffic analysing tool placed at any node or location in a data network within any device, including for example a router, and used to effectively monitor the traffic in another location through the use of the injected reference traffic.

It may further be appreciated that the subsequent analysis of the traffic may be used for a plurality of different purposes, for example, in weighted scheduler arrangements to determine the optimum weights to assign to each buffer, or as a parameter to describe traffic in a network. Such a traffic descriptor may for example include a relationship between the service rate and quality of service achieved at that service rate.

As will be appreciated by those skilled in the art, a plurality of traffic analysers according to the invention may be applied across a data network and used to provide an analysis of traffic across the entire network. Similarly, rules can be applied such that different types of data for example Voice Data, Internet Traffic etc., can be analysed using the technique of the present invention and then treated differently depending on the output of the analysis.

It will be appreciated therefore that the techniques of the present invention may by modified in a number of differing fashions depending on the applications and level of accuracy required in the calculation. In all embodiments however, the methodology of embodiments of the present invention may utilise the concept of reference packets to establish timing markers to provide a satisfactory measurement of traffic at a first location when measured at a second location.

It will be appreciated that the present invention and its use has been described with reference to graphical representations of these and as such where the present invention is described with reference to graphical representations, it will be appreciated that these graphical representations are purely for ease of understanding and are not intended to limit the present invention to these graphical representations. In particular, the present invention is not intended to be limited to the exemplary embodiments described herein, but instead is meant to include all embodiments which fall within the spirit and scope of the invention as claimed.

The words comprises/comprising when used in this specification are to specify the presence of stated features, integers, operations or components but does not preclude the presence or addition of one or more other features, integers, steps, components or groups thereof.

1. A method of analyzing traffic in a network comprising:
creating a first series of reference packets in traffic on the network at a first location and
measuring the traffic on the network at a second location, wherein the reference packets are used as timing interval markers in the measurement of the traffic.

2. A method according to claim 1, wherein the creating the first series of reference packets comprises injecting reference packets into the traffic.

3. A method according to claim 1, wherein the creating the first series of reference packets comprises of marking packets as reference packets.

4. A method according to claim 1, wherein said measurement process comprises the use of at least one counter.

5. A method according to claim 4, wherein the at least one counter is for counting the number of data packets.

6. A method according to claim 4, wherein the at least one counter is for counting the volume of data in data packets.

7. A method according to claim 4, wherein the method comprises inspecting the at least one counter at intervals defined by the reference packets.

8. A method according to claim 7, wherein the inspecting includes saving the counter values.

9. A method according to claim 1 wherein each reference packet of the first series is identified by an identifier.

10. A method according to claim 9, comprising comparing the identifier for a received reference packet in the first series with the identifier for the previously received reference packet in the first series to determine whether a reference packet has been lost.

11. A method according to claim 10 comprising calculating interpolated counter values for a reference packet lost from the first series.

12. A method according to claim 9, wherein the identifiers used for the first series of reference packets comprises a sequential sequence.

13. A method according to claim 9, wherein the identifiers used for the first series comprise a time stamp.

14. A method according to claim 1, further comprising injecting a second series of reference packets onto the network at the first location, wherein each of the reference packets in the first series comprise a first category of traffic and each of the reference packets in the second series comprise a second category of traffic.

15. A method of analyzing traffic in a network comprising:
a) identifying a reference packet from a first series of reference packets in traffic on the network, and
b) performing a measurement of the traffic using the reference packet as a timing indicator in the measurement.

16. A method according to claim 15, wherein the measurement comprises the inspection of at least one counter.

17. A method according to claim 16, wherein the at least one counter is used to count the number of data packets in the traffic.

18. A method according to claim 16, wherein the at least one counter is used to count the volume of data in data packets.

19. A method according to claim 15, further comprising saving the measurement.

20. A method according to claim 15, wherein each reference packet of the first series is identified by an identifier.

21. A method according to claim 20, comprising comparing the identifier for a received reference packet in the first series with the identifier for the previously received reference packet in the first series to determine whether a reference packet has been lost.

22. A method according to claim 21, further comprising calculating an interpolated measurement where a reference packet is lost from the first series.

23. A method according to claim 20, wherein the identifiers used for the first series of reference packets comprises a sequential sequence.

24. A method according to claim 20, wherein the identifiers used for the first series comprise a time stamp substantially identifying the time a packet was sent.

25. A method according to of claim 15, further comprising
a) identifying a reference packet from a second series of reference packets in traffic on the network, and
b) performing a measurement of the traffic in response to the identification of the reference packet from the second series.

26. A network probe for performing a measurement of network traffic, the probe comprising a first counter for recording the quantity of data in packets of an aggregate passing by the probe and a second counter for recording the number of packets of the aggregate passing by the probe, the probe being adapted to obtain a measure of the counter values in response to identifying a reference packet in a first series of reference packets.

27. A network probe according to claim 26, where the probe is adapted to store the obtained measures of the counter values.

28. A network probe according to claim 26, the probe being adapted to compare the identifier for a received reference packet in the first series with the identifier for the previously received reference packet in the first series to determine whether a reference packet has been lost.

29. A network probe according to claim 28, wherein the probe is further adapted to calculate interpolated counter values for a reference packet lost from the first series.

30. A network probe according to claim 26, wherein the first and second counters record values for traffic of a first class in the aggregate, and the probe further comprising a third counter for recording the quantity of data in packets of a second class in an aggregate passing by the probe and a fourth counter for recording the number of packets of the second class of the aggregate passing by the probe, the probe being further adapted to obtain a measure of the third and fourth counter values in response to identifying a reference packet in the second series of reference packets.

31. A reference traffic generator adapted to create a first series of reference packets for subsequent use by a probe on the network as timing markers when performing a statistical measure of traffic between the timing markers on the network.

32. A reference traffic generator according to claim 31, wherein the first series of reference packets is injected onto the network.

33. A reference traffic generator according to claim 31, wherein the first series of reference packets is created by marking existing packets in the network traffic.

34. A reference traffic generator according to claim 31, wherein the reference traffic generator is further adapted to sequentially identify each reference packet in the first series with an identifier.

35. A reference traffic generator according to claim 34, wherein the identifier comprises a time stamp.

36. A reference traffic generator according to claim 31, wherein the reference traffic generator is further adapted to place a second series of reference packets onto the network, where each of the reference packets in the first series comprises a first category of traffic and each of the reference packets in the second series comprises a second category of traffic.

37. A system comprising:
a) a network for the transmission of packets on a network,
b) a reference traffic generator configured to create a first series of reference packets for subsequent use by a probe on the network as timing markers when performing a statistical measure of traffic between the timing markers on the network,
c) a network probe for performing a measurement of network traffic, the probe comprising a first counter for recording the quantity of data in packets of an aggregate passing by the probe and a second counter for recording the number of packets of the aggregate passing by the probe, the probe being configured to obtain a measure of the counter values in response to identifying a reference packet in a first series of reference packets for performing measurements of traffic on the network using the reference packets, and
d) at least one router positioned between the reference traffic generator and the probe on the network.

38. A system according to claim 37, wherein the router comprises a WFQ scheduler.

39. A system according to claim 37, wherein the router comprises a LLQ scheduler.

40. A system according to claim 37, wherein the router comprises a priority scheduler.
